(19) United States
(12) Patent Application Publication
(10) Pub. No.: US 2024/0160219 A1
(43) Pub. Date: May 16, 2024

(54) AUTOMATED PLATOONING SYSTEM AND METHOD THEREOF

(71) Applicants: Hyundai Motor Company, Seoul (KR); Kia Corporation, Seoul (KR)

(72) Inventor: Sang Woo Hwang, Seoul (KR)

(21) Appl. No.: 18/453,582

(22) Filed: Aug. 22, 2023

(30) Foreign Application Priority Data
Nov. 15, 2022 (KR) 10-2022-0152641

(51) Int. Cl. G05D 1/02; H04W 4/44

(52) U.S. Cl. CPC G05D 1/0295; H04W 4/44; G05D 2201/0213

(57) ABSTRACT

In an embodiment, a method of controlling an automated platooning vehicle for driving on a traveling path including n-th to (n+2)-th (n is integer) sections, comprises receiving from a server information of a first leader vehicle capable of leading the automated platooning vehicle at the n-th section, performing platoon driving in association with the first leader vehicle at the n-th section, performing autonomous driving of the automated platooning vehicle out of association with the first leader vehicle at the (n+1)-th section, receiving from the server information of a second leader vehicle capable of leading the automated platooning vehicle at the (n+2)-th section, and performing platoon driving in association with the second leader vehicle at the (n+2)-th section.

### CROSS-REFERENCE TO RELATED APPLICATIONS

The present application claims priority to Korean Patent Application No. 10-2022-0152641, filed on Nov. 15, 2022, the entire contents of which is incorporated herein by reference in its entirety.

### TECHNICAL FIELD

The present disclosure relates to an automated platooning system and method thereof.

### BACKGROUND

Platooning may use Vehicle-to-Everything (V2X) technology to share vehicle control information, such as acceleration, deceleration, and stop, between a leading vehicle in which a driver is riding and following vehicles, and to share information collected through various sensors installed in the vehicle in real time, thereby enabling the following vehicles to be driven without a driver.

In the automated driving, the Level 3 or Level 4 driving except for the Level 5 of full-automated driving is performed under the specific safe conditions, which are referred to as Operational Design Domain (ODD).

In the case of an Automated Lane Keeping System (ALKS) defined as Level 3, the ODD currently is limited to a highway or a high-speed road which has a median strip and two-lanes or more.

However, when the ALKS is not able to operate even in the ODD, such as the lane is reduced or the lane is not visible due to heavy rain, for example, when there is a high possibility of leaving the ODD, the driver is warned and the control right is handed over to the driver, or the vehicle is guided to the shoulder through Minimal Risk Maneuver (MRM) or the vehicle is made to be in a safe condition such as a stop.

That is, in the related art, when the Level 3˜Level 4 driving cannot be operated or is out of the ODD, the control is handed over to the driver or the operation is stopped through the MRM.

Therefore, if the automated driving of Level 5 is not performed, the automated vehicle basically requires human monitoring and control.

### SUMMARY

The present disclosure relates to an automated platooning system and method thereof, and more particularly, to an automated platooning system and method capable of performing autonomous driving using a platooning of a surrounding vehicle according to a change in an operational design domain.

Various embodiments of the present disclosure are directed to providing a method of controlling an automated platooning vehicle, a method of operating a platooning service, and an automated platooning vehicle capable of performing automated driving by utilizing platooning of surrounding vehicles according to a change in the operational design domain.

According to an embodiment of the present disclosure, method of controlling an automated platooning vehicle for driving on a traveling path including n-th to (n+2)-th (n is integer) sections, the method includes receiving from a server information of a first leader vehicle capable of leading the automated platooning vehicle during the n-th section, performing platoon driving in association with the first leader vehicle, performing autonomous driving of the automated platooning vehicle out of association with the first leader vehicle during the (n+1)-th section, receiving from the server information of a second leader vehicle capable of leading the automated platooning vehicle during the (n+2)-th section, and performing platoon driving in association with the second leader vehicle during the (n+2)-th section.

In at least one embodiment of the present disclosure, the performing of the autonomous driving during the (n+1)-th section comprises transmitting a request for information of at least one subscriber leader vehicle traveling around the traveling path to the server when a predetermined event situation occurs.

In at least one embodiment of the present disclosure, the performing of the autonomous driving during the (n+1)-th section further comprises performing platoon driving in association with a subscriber leader vehicle whose information is received from the server.

In at least one embodiment of the present disclosure, the performing of the autonomous driving during the (n+1)-th section further comprises autonomously driving again the automated platooning vehicle out of association with the subscriber leader vehicle when the event situation is terminated.

In at least one embodiment of the present disclosure, the performing of the autonomous driving during the (n+1)-th section further comprises selecting one among the at least one subscriber leader vehicle based on information of the at least one subscriber leader vehicle received from the server.

In at least one embodiment of the present disclosure, the automated platooning vehicle can be an unmanned vehicle.

A method of operating a platooning service for an automated platooning vehicle traveling on a traveling path including n-th to (n+2)-th (n is integer) sections, according to an embodiment of the present disclosure, comprises calling, by a server, a first leader vehicle capable of leading the automated platooning vehicle during the n-th section, performing, by the automated platooning vehicle, platoon driving in association with the first leader vehicle, performing, by the automated platooning vehicle, autonomous driving out of association with the first leader vehicle during the (n+1)-th section, calling, by the server, a second leader vehicle capable of leading the automated platooning vehicle during the (n+2)-th section, and performing, by the automated platooning vehicle, platoon driving in association with the second leader vehicle during the (n+2)-th section.

In at least one embodiment of the method of operating the platooning service, the performing of the autonomous driving comprises transmitting, by the automated platooning vehicle, a request for information of at least one subscriber leader vehicle traveling around the traveling path to the server when a predetermined event situation occurs.

In at least one embodiment of the method of operating the platooning service, the performing of the autonomous driving further comprises performing, by the automated platooning vehicle, platoon driving in association with a subscriber leader vehicle whose information is received from the server.

In at least one embodiment of the method of operating the platooning service, the performing of the autonomous driving further comprises autonomously driving again by the automated platooning vehicle out of association with the subscriber leader vehicle when the event situation is terminated.

In at least one embodiment of the method of operating the platooning service, the performing of the autonomous driving further comprises selecting, by the automated platooning vehicle, one among the at least one subscriber leader vehicle based on information of the at least one subscriber leader vehicle received from the server.

In at least one embodiment of the method of operating the platooning service, the automated platooning vehicle is an unmanned vehicle.

An automated platooning vehicle capable of connecting communicatively to a server during a traveling path including an n-th section to an (n+2)-th section, according to an embodiment of the present disclosure, comprises a computer-readable recording medium storing a computer program of performing platoon driving and autonomous driving and a processor configured to execute the computer program, wherein the processor is configured to perform receiving from a server information of a first leader vehicle capable of leading the automated platooning vehicle during the n-th section, performing platoon driving in association with the first leader vehicle, performing autonomous driving of the automated platooning vehicle out of association with the first leader vehicle during the (n+1)-th section, receiving from the server information of a second leader vehicle capable of leading the automated platooning vehicle during the (n+2)-th section, and performing platoon driving in association with the second leader vehicle during the (n+2)-th section.

In at least one embodiment of the automated platooning vehicle, the performing of the autonomous driving during the (n+1)-th section comprises transmitting a request for information of at least one subscriber leader vehicle traveling around the traveling path to the server when a predetermined event situation occurs.

In at least one embodiment of the automated platooning vehicle, the performing of the autonomous driving during the (n+1)-th section further comprises performing platoon driving in association with a subscriber leader vehicle whose information is received from the server.

In at least one embodiment of the automated platooning vehicle, the performing of the autonomous driving during the (n+1)-th section further comprises autonomously driving again the automated platooning vehicle out of association with the subscriber leader vehicle when the event situation is terminated.

In at least one embodiment of the automated platooning vehicle, the performing of the autonomous driving during the (n+1)-th section further comprises selecting one among the at least one subscriber leader vehicle based on information of the at least one subscriber leader vehicle received from the server.

In at least one embodiment of the automated platooning vehicle, the automated platooning vehicle can be an unmanned vehicle.

The present disclosure can provide a service corresponding to Level 5 autonomous driving at the Level 4 automated driving technology level.

According to embodiments of the present disclosure, it is possible to perform a completely unmanned driving according to whether a driver is required or not, thereby maximizing efficiency in human use.

According to embodiments of the present disclosure, when autonomous driving is not possible due to a special situation in the ODD, platooning with a surrounding vehicle can be used, thereby rapidly resuming driving.

In the present disclosure, in the case of the cargo-type APV (automated platooning vehicle), because the cargo-type APV and the platooning PLV (pilot leader vehicle) can be driven while being separated from each other, there is not necessarily a need to cope with a change in ride comfort due to a change in weight of the cargo-type APV. Accordingly, the PLV can transport cargo while maintaining good riding comfort.

The effects obtainable from embodiments of the present disclosure are not necessarily limited to the above-mentioned effects, and other effects not described herein can be clearly understood by those skilled in the art from the following description.

### BRIEF DESCRIPTION OF THE DRAWINGS

FIG. 1 is a diagram for describing a configuration of an automated platooning system according to an embodiment of the present disclosure.

FIG. 2 is a diagram for describing a basic operation of an automated vehicle and a main server according to an embodiment of the present disclosure.

FIG. 3 illustrates an example of a basic operation between automated driving vehicles using wireless communication.

FIG. 4 is an example of V2X communication that can be applied in an embodiment.

FIG. 5 is a control block diagram of a platooning leader vehicle according to an embodiment of the present disclosure.

FIG. 6 is a diagram for describing an operating method of an automated platooning system according to an embodiment of the present disclosure.

FIG. 7 is a diagram illustrating an operation of a main server according to an embodiment of the present disclosure.

FIG. 8 is a diagram for describing an operation of an automated driving vehicle according to an embodiment of the present disclosure.

FIG. 9 is a diagram illustrating an operation of the pilot leader vehicle (PLV) according to an embodiment of the present disclosure.

### DETAILED DESCRIPTION OF ILLUSTRATIVE EMBODIMENTS

Hereinafter, embodiments disclosed in the present specification will be described in detail with reference to the accompanying drawings, in which like or similar feature elements can be assigned like reference numerals regardless of the reference numerals, and redundant descriptions thereof may be omitted.

In the following description, a suffix “unit” for a feature element can be given or used in combination considering only the ease of preparation of the specification, and is not necessarily physically divided or separated. For example, the “00 unit” can be a feature element that performs a function different from the “xx unit”, but according to an embodiment, the functions can be implemented to be performed in parallel or time-sequentially in one identical microprocessor without being physically divided or separated, and the suffix “unit” does not exclude the functions. This is also applied to the suffix “module.”

In addition, in describing the embodiments disclosed in the present specification, when it is determined that the detailed description of the related known technology can obscure the gist of the embodiments disclosed in the present specification, the detailed description thereof may be omitted.

In addition, the accompanying drawings are merely for easily understanding the embodiments disclosed in the present specification, and the technical spirit disclosed in embodiments of the present specification are not necessarily limited by the accompanying drawings, and it should be understood that all changes, equivalents, and substitutes included in the spirit and technical scope of the present specification can be included.

Terms including ordinal numbers such as first, second, etc. can be used to describe various feature elements, but the feature elements are not necessarily limited by the terms. The terms can be used only for the purpose of distinguishing one feature element from another feature element, and in particular, should not necessarily be construed as determining an order between feature elements by using only the name.

In addition, the criteria for “up/above” or “down/below” is used to represent a relative position relationship between feature elements based on the shape shown in the drawings for convenience in principle, unless it is naturally determined from each of the feature elements or an attribute between the feature elements or otherwise expressed in the specification, and should not necessarily be understood as limiting the actual position of the display elements. For example, “B located above” can be merely an indication that B is shown above A in the drawings, unless otherwise stated or B should not be located above A due to the property of A or B, and in the actual product or the like, B can be located below A and B and A can be disposed side by side.

The term “and/or” can be used to include any combination of a plurality of items to be included. For example, “A and/or B” includes all three cases such as “A,” “B,” and “A and B.”

When it is mentioned that a feature element is “connected” or “linked” to another feature element, it should be understood that another feature element can exist in the middle, although it can be directly connected or connected to the other feature element. On the other hand, when it is mentioned that a feature element is “directly connected” or “directly linked” to another feature element, it should be understood that there is no other feature element therebetween.

A singular expression includes a plural expression unless the context clearly indicates otherwise.

In this specification, it should be understood that the term “include” or “have” indicates that a feature, a number, a step, an operation, a feature element, a part or a combination thereof described in the specification is present, but does not exclude the possibility of presence or addition of one or more other features, numbers, steps, operations, feature elements, parts, or combinations thereof, in advance.

Unless otherwise defined, all terms used herein, including technical or scientific terms, can have the same meaning as that generally understood by those skilled in the art to which this specification belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In addition, a unit or a control unit is a term widely used in a name of a controller that outputs a control value or a command for a specific function with respect to another feature element, but does not mean a generic function unit. For example, each unit or control unit can include an input/output device for exchanging signals with another controller or sensor to control a function in charge, a memory for storing an operating system or a logic command, input/output information, and the like, and one or more microprocessors for performing determination, calculation, determination, and the like necessary for controlling a function in charge.

Hereinafter, the operation principle and embodiments of the present disclosure will be described with reference to the accompanying drawings.

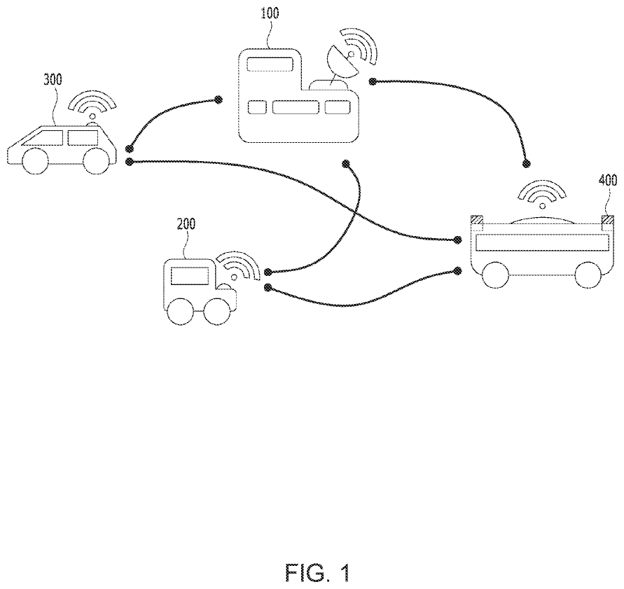

FIG. 1 is a diagram for describing a feature of an automated platooning system according to an embodiment of the present disclosure.

Referring to FIG. 1, an automated platooning system according to an embodiment of the present disclosure can include a main server 100 wirelessly communicating with a plurality of automated driving vehicles 200, 300, and 400.

The main server 100 can control the platooning service and automated driving. The main server 100 can be referred to as a service headquarter or a service center. The main server 100 can be connected to the plurality of automated vehicles 200, 300, and 400 in travelling via a wireless network, and can receive and/or provide real-time operation information, real-time current position information, and/or road information on a road in travelling from the plurality of automated vehicles.

A plurality of automated vehicles 200, 300, and 400 can be defined as a transport system driving on a road or a track. For example, the plurality of automated vehicles 200, 300, and 400 can be a vehicle capable of autonomous driving and can be a concept including all of an internal combustion engine vehicle including an engine as a power source, a hybrid vehicle including an engine and an electric motor as a power source, an electric vehicle including an electric motor as a power source, and the like.

The plurality of automated driving vehicles 200, 300, and 400 can include an Automated Platooning Vehicle (APV) 400 and at least one Platooning Leader Vehicle (PLV) 200, 300.

The APV 400 can be a vehicle capable of utilizing the entire space as a passenger space/cargo space without a driver's seat. For example, the APV 400 can perform autonomous driving of Level 4 and platooning following the PLV 200 or 300 through V2X communication. The APV 400 can be referred to as an APV. For example, the APV 400 can be a trailer capable of autonomous driving.

The leader vehicle (PLV) 200, 300 can be a vehicle that leads at least a partial section or all sections of the APV 400 from a point of departure to a destination. The leader vehicle (PLV) 200, 300 can be referred to as a PLV.

The leader vehicle (PLV) 200, 300 can perform platooning while leading at least one APV 400. For example, when the plurality of APVs 400 include first to n-th automated platooning vehicles, one leader vehicle (PLV) 200 or 300 can perform platooning while leading the first to n-th automated platooning vehicles. However, embodiments of the present disclosure are not necessarily limited thereto, and one leader vehicle (PLV) 200 or 300 can be physically separated from the first to nth automated platooning vehicles for a predetermined time in consideration of the driving environment or the road environment, and then can be coupled again to perform platooning.

The PLV 200, 300 can include a pilot leader vehicle PLV-p 200 and a subscriber leader vehicle PLV-s 300.

The pilot leader vehicle (PLV-p) 200 can be a vehicle that leads to platooning an APV in a non-ODD section, and can be boarded by a driver. For example, the PLV-p 200 can lead the APV 400 so as to perform platooning, and can lead the APV 400 in a section other than an ODD that is scheduled, such as a first section and a last section of the entire autonomous driving path.

For example, when the ODD is a highway, the PLV-p 200 can travel in a group while leading the APV 400 from a starting point until the vehicle enters the highway. Further, the PLV-p 200 can travel in a group while leading the APV 200 until reaching a destination after getting out of the highway.

The subscriber leader vehicle (PLV-s) 300 can be a vehicle that temporarily leads the APV 400 to platooning, and can be a vehicle that has subscribed to a platooning support service. For example, when subscribing to the platooning support service, the PLV-s 300 can provide a predetermined/selected reward to the subscriber instead of helping the autonomous driving of the APV 400.

The PLV-s 300 can transmit and receive information to and from the APV 400 via V2X communication. A detailed description thereof will be described later.

The PLV-s 300 can transmit its destination and path to the service headquarters, which can be the main server 100, and when the APV 400 includes a path capable of breaking through a section in which autonomous driving is impossible, the PLV-s 300 can temporarily travel in a group to lead the APV 400 in that section.

That is, the APV 400 can basically autonomously drive in the ODD, but when autonomous driving is temporarily impossible due to unusual matters or events, the APV 400 can select a PLV-s 300 driving in the vicinity of the APV and temporarily follow the selected PLV-s 300.

In addition, the main server 100 can search for the PLV-s 300 in real time while the APV 400 is autonomously driving in the ODD, and can provide search information for the same to the APV 400.

The PLV-p 200, the PLV-s 300, and the APV 400 can communicate with the main server 100 using a wireless network, and each of the PLV-p 200, the PLV-s 300, and the APV 400 can perform platooning using vehicle-to-vehicle (V2V) communication. A detailed description thereof will be described later.

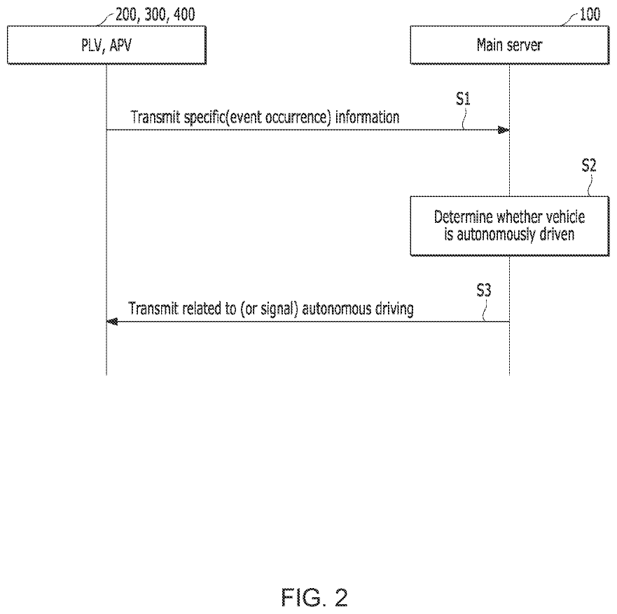

FIG. 2 is a diagram for describing a basic operation of an automated vehicle and a main server according to an embodiment of the present disclosure.

Referring to FIG. 2, the autonomous vehicles 200, 300, and 400 can transmit specific information to the main server 100 using a wireless network (operation S1). The specific information can include information related to autonomous driving, locations of the automated vehicles 200, 300, and 400, driving information, information related to a platooning service, and the like, for example.

The main server 100 can determine whether the automated vehicles 200, 300, and 400 are autonomously driven or whether a platooning service is provided (operation S2). Here, the main server 100 can include a server or module for performing autonomous driving-related control or a server or module for controlling or performing platooning services. For example, the main server 100 can be referred to as a service headquarter.

In addition, the main server 100 can transmit information (or signal) related to autonomous driving control or information (or signal) related to platooning service to the automated driving vehicles 200, 300, and 400 (operation S3).

For example, as in operations S1 and S3 of FIG. 2, in order for the autonomous vehicle 200, 300, and 400 to transmit/receive signals, information, and the like to/from the main server 100 using the wireless network, the automated driving vehicle 200, 300, and 400 can perform an initial access procedure and a random access procedure with the main server 100 or the wireless network before operation S1 of FIG. 2.

More specifically, the automated driving vehicles 200, 300, and 400 can perform an initial access procedure with the wireless network or the main server 100 based on a single side band (SSB) to obtain DL (communication from the first communication device to the second communication device) synchronization and system information.

A beam management (BM) process and a beam failure recovery procedure can be added to the initial access procedure, and a quasi-co-location (QCL) relationship can be added in the procedure that the automated driving vehicles 200, 300, and 400 receive a signal from the wireless network or the main server 100.

In addition, the automated driving vehicles 200, 300, and 400 can perform a random access procedure with a wireless network or the main server 100 for UL (communication from the second communication device to the first communication device) synchronization acquisition and/or UL transmission. The main server 100 can transmit a UL grant for scheduling transmission of specific information to the automated driving vehicles 200, 300, and 400 using a wireless network.

The automated driving vehicles 200, 300, and 400 can transmit specific information to the main server 100 through a wireless network based on UL grant. The main server 100 can transmit DL grant for scheduling transmission of a wireless processing result for specific information to the automated vehicles 200, 300, and 400 through a wireless network.

Therefore, the main server 100 can transmit information (or signal) related to autonomous driving control or information (or signal) related to platooning service to the automated vehicles 200, 300, and 400 based on DL grant based via a wireless network.

After the automated driving vehicles 200, 300, and 400 perform the initial access procedure and/or the random access procedure with the wireless network, the automated driving vehicles 200, 300, and 400 can receive the DownlinkPreemption Information Element (IE) from the wireless network. In addition, the automated driving vehicles 200, 300, and 400 can receive the Downlink Control Information (DCI) format 2_1 including a pre-emption indication from the main server 100 based on the DownlinkPreemption IE.

Further, the automated driving vehicles 200, 300, and 400 do not perform (or expect or assume) reception of the enhanced mobile broadband (eMBB) data in the resources, physical resource block (PRB), and/or orthogonal frequency division multiplexing (OFDM) symbols indicated by the pre-emption indication. Thereafter, when it is necessary to transmit specific information, the automated driving vehicles 200, 300, and 400 can receive the UL grant from the main server 100 through the wireless network.

That is, in operation S1 of FIG. 2, the automated driving vehicles 200, 300, or 400 can receive the UL grant from the main server 100 through the wireless processor to transmit the specific information to the main server 100. The UL grant can include information on the number of times of repetition of transmission of specific information, and the specific information can be repeatedly transmitted based on information on the number of times of repetition. That is, the automated driving vehicles 200, 300, and 400 can transmit the specific information to the main server 100 using a wireless network based on the UL grant. In addition, repetitive transmission of the specific information can be performed through frequency hopping, transmission of a first specific information can be transmitted through a first frequency resource, and transmission of a second specific information can be transmitted through a second frequency resource. The specific information can be transmitted through a narrowband of 6RB (Resource Block) or 1RB (Resource Block).

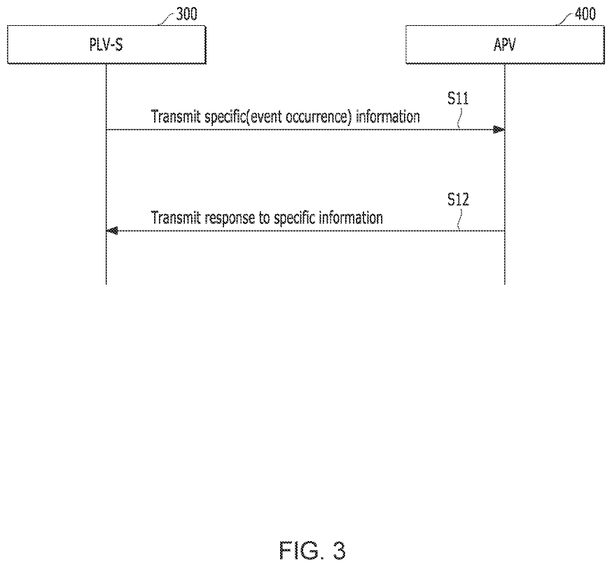

FIG. 3 illustrates an example of a basic operation between automated vehicles using wireless communication.

Referring to FIG. 3, the PLV-s 300 can transmit specific information to the APV 400 (operation S11). The APV 400 can transmit a response to the specific information to the PLV-s 300 (operation S12).

Meanwhile, a configuration of an application operation between vehicles can vary according to whether the wireless network is directly (sidelink communication transmission mode 3) or indirectly (sidelink communication transmission mode 4) involved in resource allocation of a response to the specific information.

Next, application operations between vehicles using wireless communication will be described.

First, a method in which a wireless network is directly involved in resource allocation of signal transmission/reception between vehicles can be described.

The wireless network can transmit DCI format 5A to the first vehicle for scheduling of mode 3 transmission (PSCCH and/or PSSCH transmission). A physical sidelink control channel (PSCCH) can be a wireless physical channel for scheduling transmission of the specific information, and a physical sidelink shared channel (PSSCH) can be a wireless physical channel for transmitting the specific information. In addition, the PLV-s 300 can transmit the SCI format 1 for scheduling transmission of the specific information to the APV 400 on the PSCCH. Further, the PLV-s 300 can transmit the specific information to the automated platooning vehicle APV 400 on the PSSCH.

Next, a method of indirectly involving a wireless network in resource allocation of signal transmission/reception will be described.

The subscriber leader vehicle PLV-s 300 can sense a resource for mode 4 transmission in the first window. In addition, the PLV-s 300 can select a resource for mode 4 transmission in the second window based on the sensing result. The first window can refer to a sensing window, and the second window can refer to a selection window.

The PLV-s 300 can transmit the SCI format 1 for scheduling transmission of specific information on the basis of the selected resource to the APL 400 on the PSCCH. In addition, the PLV-s 300 can transmit the specific information to the APL 400 on the PSSCH.

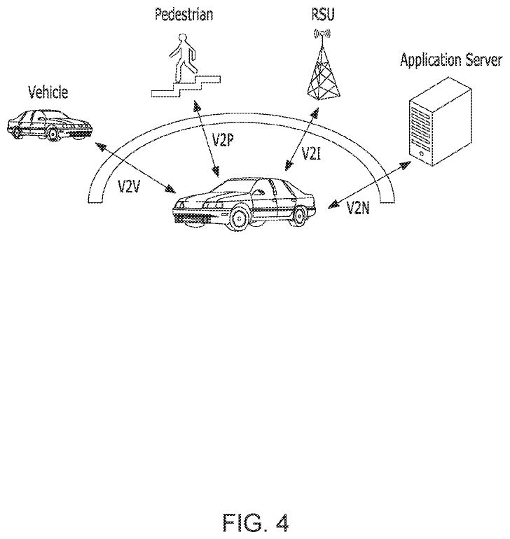

FIG. 4 is an example of V2X communication to which the present disclosure can be applied.

Referring to FIG. 4, vehicle-to-everything (V2X) communication can include vehicle-to-vehicle (V2V) communication between vehicles, vehicle-to-infrastructure (V2I) communication between vehicles and Evolved Node B (eNB) or road side units (RSU), vehicle-to-pedestrian (V2P) communication between vehicles and user equipments (UEs) that individuals (pedestrians, bicycle drivers, vehicle drivers, or passengers) hold and vehicle-to-network (V2N) communications between vehicles and all entities.

The V2X communication can have the same meaning as the V2X sidelink or the NR V2X or can have a broader meaning including the V2X sidelink or the NR V2X.

The V2X communication can be applied to various services, for example, a forward collision warning, an automatic parking system, a CACC (Cooperative adaptive cruise control), a loss of control warning, a traffic matrix warning, a safety warning for the vulnerable in traffic, an emergency vehicle warning, a speed warning when driving on a curved road, a traffic flow control, and the like, for example.

The V2X communication can be provided via a PC5 interface and/or a Uu interface (a name designated for the wireless link between the end user device and the wireless base station by 3GPP (3rd Generation Partnership Project IMT-2000)). In this case, specific network entities for supporting communication between the vehicle and all the entities can exist in the wireless communication system supporting V2X communication. For example, the network entity can be a BS (eNB), a road side unit (RSU), or an application server (e.g., a traffic safety server), and the like.

In addition, the UE (User Equipment) performing V2X communication can mean not only a general handheld UE but also a vehicle UE (V-UE (Vehicle UE)), a pedestrian UE, an RSU of a BS type (eNB type), an RSU of a UE type, a robot having a communication module, and the like, for example.

The V2X communication can be performed directly between the UEs, or through network entity(s). The V2X operation mode can be classified according to the method of performing V2X communication.

The V2X communication is required to support the pseudonymity and privacy of UE upon a use of V2X application so that an operator or a third party cannot track UE identifier within an area where V2X is supported.

Terms frequently used in V2X communication can be defined as follows.

Road Side Unit (RSU): The RSU can be a V2X service-enabled device that can transmit/receive data to/from a moving vehicle using a V2I service. Also, the RSU can be a fixed infrastructure entity supporting the V2X application, and can exchange messages with other entities supporting the V2X application. The RSU is a term frequently used in the existing ITS specification, and the reason for introducing this term into the 3GPP specification is to enable the ITS industry to easily further read documents. The RSU is a logical entity that combines V2X application logic with functions of a BS (referred to as a BS-type RSU) or a UE (referred to as a UE-type RSU).

V2P service: A type of V2X service, in which one side is a vehicle and the other side is a device carried by an individual (e.g., a pedestrian, a bicyclist, a driver, or a fellow passenger).

V2P service: A type of V2X service, in which one side is a vehicle and the other side is a device carried by an individual (e.g., a pedestrian, a bicyclist, a driver, or a fellow passenger).

V2X service: 3GPP communication service type in which a transmission or reception device is related to a vehicle.

2X enabled UE: UE supporting V2X service.

V2V service: a type of V2X service, and both communication are vehicles.

V2V communication range: a direct communication range between two vehicles participating in a V2V service.

The V2X application called Vehicle-to-Everything (V2X) can have four types: (1) Vehicle-to-Vehicle (V2V), (2) Vehicle-to-Infrastructure (V2I), (3) Vehicle-to-Network (V2N), and (4) Vehicle-to-Pedestrian (V2P).

It can be used as the following example through the above-described V2X communication. However, it is not necessarily limited thereto.

(1) Vehicle Platooning can dynamically form a platoon in which vehicles move together. All vehicles in platooning can get information from the leader vehicle to manage this platoon. This information can allow the vehicle to be driven more harmoniously than in the normal direction, to go in the same direction, and to be driven together. A detailed description thereof will be described later.

(2) Extended sensors enable the vehicle, road site unit, pedestrian device, and V2X application server to exchange raw or processed data collected through local sensors or live video images. A vehicle can increase awareness of the environment more than its own sensors can detect, and can grasp the situation in a broader and overall manner. A high data transfer rate can be one of the main features.

(3) Advanced driving can allow semi-automatic or fully-automatic driving. Each vehicle and/or RSU can share its own recognition data obtained from the local sensor with a nearby vehicle and allow the vehicle to synchronize and adjust trajectory or maneuver. Each vehicle can share driving intention with the adjacent driving vehicle.

(4) Remote driving can allow a remote driver or V2X application to drive a remote vehicle for passengers who cannot drive on their own or with the remote vehicle in a dangerous environment. When fluctuations are limited and paths can be predicted such as public transportation, cloud computing-based driving can be used. High reliability and low latency can be key requirements.

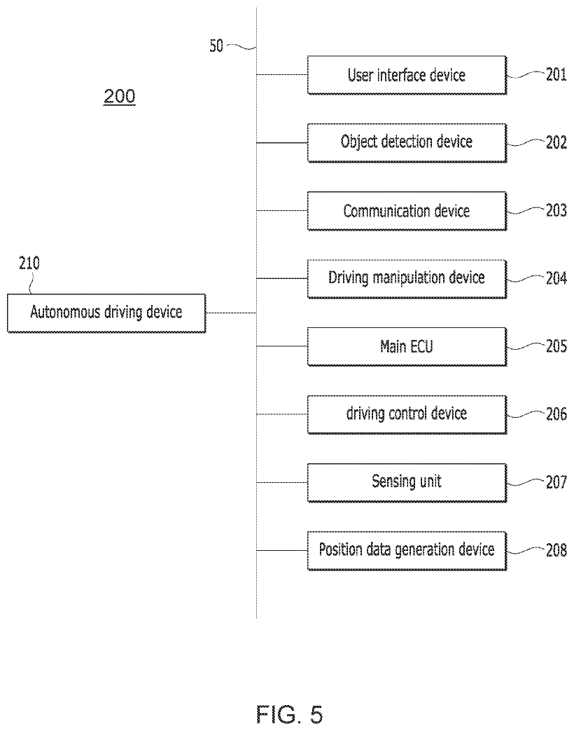

FIG. 5 is a control block diagram of a Platooning Leader vehicle according to an embodiment of the present disclosure.

Referring to FIG. 5, the PLV-p 200 can include a user interface device 201, an object detection device 202, a communication device 203, a driving manipulation device 204, a main ECU 205, a driving control device 206, an autonomous driving device 210, a sensing unit 207, and a position data generation device 208, for example.

The object detection device 202, the communication device 203, the driving manipulation device 204, the main ECU 205, the driving control device 206, the autonomous driving device 210, the sensing unit 207, and the position data generation device 208 can be implemented as electronic devices that generate electrical signals and exchange electrical signals with each other.

The user interface device 201 can be a device for communication between the PLV-p 200 and a user. The user interface device 201 can receive a user input and provide information generated by the PLV-p 200 to the user. The PLV-p 200 can implement a user interface (UI) or a user experience (UX) through the user interface device 201. The user interface device 201 can include an input device, an output device, and a user monitoring device, for example.

The object detection device 202 can generate information about an object outside the PLV-p 200. The information about the object can include at least one of information about whether the object exists, location data of the object, information about a distance between the PLV-p 200 and the object, and information about a relative speed between the PLV-p 200 and the object. The object detection device 202 can detect an object outside the PLV-p 200. The object detection device 202 can include at least one sensor capable of detecting objects outside the PLV-p 200.

For example, the object detection device 202 can include a camera, a radar, a lidar, an ultrasonic sensor, an infrared sensor, or any combination thereof. The object detection device 202 can provide data about the object generated based on a sensing signal generated by a sensor to at least one electronic device included in the PLV-p 200.

The camera can generate information about an object outside the PLV-p 200 using an image. The camera can include at least one lens, at least one image sensor, and at least one processor electrically connected to the image sensor to process a received signal and to generate data for an object based on the processed signal.

The camera can be a mono camera, a stereo camera, an around view monitoring (AVM) camera, or any combination thereof. The camera can acquire location data of an object, a distance information to the object, or a relative speed information with the object by using various image processing algorithms. For example, the camera can acquire the distance information and the relative speed information from the object based on a change in the size of the object over time in the acquired image.

For example, the camera can acquire the distance information and the relative speed information with the object through a pin-hole model, a road surface profiling, or the like. For example, the camera can acquire the distance information and the relative speed information with the object based on disparity information in stereo images acquired by the stereo camera.

The camera can be mounted at a position where a field of view (FOV) can be secured in the PLV-p 200 to photograph the outside of the pilot leader vehicle PLV-p 200. The camera can be disposed in the interior of the PLV-p 200 close to a front windshield to acquire an image in front of the PLV-p 200. The camera can be located around the front bumper or the radiator grill. The camera can be located close to the rear glass inside the PLV-p 200 to acquire an image of the rear side of the PLV-p 200. The camera can be located around the rear bumper, trunk, or tailgate. The camera can be located close to at least one of the side windows inside the pilot leader vehicle PLV-p 200 to acquire an image of the side of the pilot leader vehicle PLV-p 200. Alternatively, the camera can be located around a side mirror, a fender, or a door.

The radar can generate information on an object outside the PLV-p 200 by using the electric wave. The radar can include at least one processor that is electrically connected to an electromagnetic wave transmitter, an electromagnetic wave receiver, and an electromagnetic wave transmitter and receiver, processes a received signal, and generates data for an object based on a processed signal.

The radar can be implemented by a pulse radar method or a continuous wave radar method according to the principle of radio wave emission. The radar can be implemented in a Frequency Modulated Continuous Wave (FMCW) scheme or a Frequency Shift Keying (FSK) scheme according to a signal waveform among continuous wave radar schemes. The radar can detect an object based on a time of flight (TOF) scheme or a phase-shift scheme by using electromagnetic waves, and can detect a position of the detected object, a distance from the detected object, and a relative speed.

The radar can be located at an appropriate location outside the PLV-p 200 to sense an object located in front, rear, or side of the PLV-p 200.

Lidar can generate information on an object outside the PLV-p 200 by using laser light. The lidar can include at least one processor electrically connected to an optical transmission unit, an optical reception unit, and an optical transmission and reception unit, processing a received signal, and generating data for an object based on a processed signal.

The lidar can be implemented by a time of flight (TOF) scheme or a phase-shift scheme. The lidar can be implemented as a driving type or a non-driving type. When implemented in the driving type, the lidar can be rotated by a motor and can detect an object around the PLV-p 200. When implemented in a non-driving type, the lidar can detect an object located within a predetermined range with reference to the PLV-p 200 by optical steering. The PLV-p 200 can include a plurality of non-driving lidars. The lidar can detect an object using laser light, based on the time of flight (TOF) scheme or the phase-shift scheme, and can detect a position of the detected object, a distance from the detected object, and a relative speed. The lidar can be located at an appropriate location outside the PLV-p 200 to sense an object located in front, back, or side of the PLV-p 200.

The communication device 203 can exchange signals with a device located outside the PLV-p 200. The communication device 203 can exchange signals with an infrastructure (for example, a server, a broadcasting station), another vehicle, a terminal, or any combination thereof. The communication device 203 can include a transmission antenna, a reception antenna, a radio frequency (RF) circuit capable of implementing various communication protocols, an RF element to perform communication, or any combination thereof.

For example, the communication device 203 can exchange signals with an external device based on a cellular V2X (C-V2X) technology. For example, the C-V2X technology can include LTE-based sidelink communication and/or NR-based sidelink communication. The C-V2X will be described later. The external device can include a main server 100, a subscriber leader vehicle (PLV-s), and an APV.

For example, the communication device 203 can exchange signals with an external device based on DSRC (Dedicated Short Range Communications) technology based on IEEE 802.11p PHY/MAC layer technology and IEEE 1609 Network/Transport layer technology or WAVE (Wireless Access in Vehicular Environment) standard. DSRC (or WAVE standard) technology is a communication standard prepared to provide an intelligent transport system (ITS) service through short-range dedicated communication between vehicle-mounted devices or between a roadside device and a vehicle-mounted device. The DSRC technology can use a frequency of 5.9 GHz band and can be a communication scheme having a data transmission speed of 3 Mbps-27 Mbps. IEEE 802.11p technology can be combined with IEEE 1609 technology to support DSRC technology (or WAVE standard).

The communication device 203 according to an embodiment of the present disclosure can exchange signals with an external device by using only one of C-V2X technology and DSRC technology. Alternatively, the communication device 203 of an embodiment can exchange signals with an external device by hybridizing the C-V2X technology and the DSRC technology.

The driving manipulation device 204 can be a device that receives a user input for driving. In the manual mode, the PLV-p 200 can be driven based on a signal provided by the driving manipulation device 204. The driving manipulation device 204 can include a steering input device (e.g., a steering wheel), an acceleration input device (e.g., an acceleration pedal), and a brake input device (e.g., a brake pedal).

The main ECU 205 can control the overall operation of at least one electronic device provided in the PLV-p 200.

The driving control device 206 can be a device for electrically controlling various vehicle driving devices in the PLV-p 200. The driving control device 206 can include a powertrain driving control device, a chassis driving control device, a door/window driving control device, a safety device driving control device, a lamp driving control device, and an air conditioning driving control device, for example.

For example, the powertrain driving control device can include a power source driving control device and a transmission driving control device. The chassis driving control device can include a steering driving control device, a brake driving control device, and a suspension driving control device. And, the safety device driving control device can include a safety belt driving control device for safety belt control.

The driving control device 206 can include at least one electronic control device (for example, a control electronic control unit (ECU)). The driving control device 206 can control the pilot leader vehicle PLV-p 200 based on a signal received from the autonomous driving device 210.

For example, the driving control device 206 can control the power train, the steering device, and the brake device based on a signal received from the autonomous driving device 210.

The autonomous driving device 210 can generate a path for autonomous driving based on the obtained data. The autonomous driving device 210 can generate a driving plan for driving along the generated path. The autonomous driving device 210 can generate a signal for controlling the movement of the PLV-p 200 according to the driving plan. The autonomous driving device 210 can provide the generated signal to the driving control device 206.

The autonomous device 210 can implement at least one advanced driver assistance system (ADAS) function. The ADAS can implement an Adaptive Cruise Control (ACC), an Autonomous Emergency Braking (AEB), a Forward Collision Warning (FCW), a Lane Keeping Assist (LKA), a Lane Change Assist (LCA), a Target Following Assist (TFA), a Blind Spot Detection (BSD), an High Beam Assist (HBA), an Auto Parking System (APS), a PD collision warning system, a Traffic Sign Recognition (TSR), a Traffic Sign Assist (TSA), a Night Vision (NV), a Driver Status Monitoring (DSM), a Traffic Jam Assist (TJA), or any combination thereof, for example.

The autonomous driving device 210 can perform a switching operation from the autonomous driving mode to the manual driving mode, or a switching operation from the manual driving mode to the autonomous driving mode. For example, the autonomous driving device 210 can switch the mode of the PLV-p 200 from the autonomous driving mode to the manual driving mode, or from the manual driving mode to the autonomous driving mode, based on a signal received from the user interface device 201.

The sensing unit 207 can sense a state of the pilot leader vehicle PLV-p 200. The sensing unit 207 can include an inertial measurement unit (IMU) sensor, a collision sensor, a wheel sensor, a speed sensor, a tilt sensor, a weight sensor, a heading sensor, a position module, a PLV-p 200 forward/backward movement sensor, a battery sensor, a fuel sensor, a tire sensor, a steering sensor, a temperature sensor, a humidity sensor, an ultrasonic sensor, an illumination sensor, a pedal position sensor, or any combination thereof, for example.

An inertial measurement unit (IMU) sensor can include one or more of an acceleration sensor, a gyro sensor, and a magnetic sensor.

The sensing unit 207 can generate state data of the pilot leader vehicle PLV-p 200 based on a signal generated by the at least one sensor. The vehicle state data can be information generated based on data sensed by various sensors provided inside the PLV-p 200.

For example, the sensing unit 207 can generate vehicle body data, vehicle motion data, vehicle yaw data, vehicle roll data, vehicle pitch data, vehicle collision data, vehicle direction data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illuminance data, pressure data applied to an acceleration pedal, and pressure data applied to a brake pedal, etc.

The position data generation device 208 can generate position data of the PLV-p 200. The position data generating device 208 can include a global positioning system (GPS) and/or a differential global positioning system (DGPS). The position data generation device 208 can generate position data of the PLV-p 200 based on a signal generated by the GPS and/or the DGPS. According to an embodiment of the present disclosure, the position data generating device 208 can correct the position data based on an inertial measurement unit (IMU) of the sensing unit 207 and/or a camera of the object detecting device 202.

The position data generation device 208 can be referred to as a global navigation satellite system (GNSS).

The above-described pilot leader vehicle (PLV-p) 200 can include the internal communication system 50. The plurality of electronic devices included in the PLV-p 200 can exchange signals via the internal communication system 50. Data can be included in the signals. The internal communication system 50 can use at least one communication protocol (e.g., CAN, LIN, FlexRay, MOST, Ethernet).

As described above, in FIG. 5, the pilot leader vehicle PLV-p 200 among the Platooning Leader vehicles will be mainly described. Because the subscriber leader vehicle PLV-s 300 can have substantially the same feature, function, and the like as those of the PLV-p 200, which will be described later, a repeated description thereof will be omitted.

Based on the above description, an embodiment of an automated platooning system and method will be hereinafter described in detail.

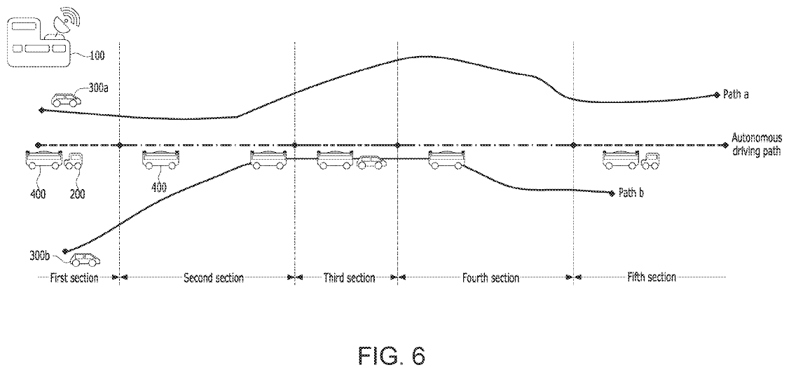

FIG. 6 is a diagram for describing an automated platooning system and method according to an embodiment of the present disclosure.

Referring to FIG. 6, an operation method of the automated platooning system according to an embodiment of the present disclosure will be described.

The automated driving vehicle APV 400 can perform autonomous driving using an autonomous driving path. As illustrated in FIG. 6, the autonomous driving path can include first to fifth sections.

The second to fourth sections, which are the remaining sections other than the first section and the fifth section, can be an operational design domain.

The subscriber leader vehicle PLV-s 300 can be at least one. For example, the PLV-s 300 can include a first PLV-s1 300a and a second PLV-s2 300b.

The first subscriber leader vehicle PLV-s1 300a can drive along a “path a”. In addition, the second subscriber leader vehicles PLV-s2 300b can travel on a “path b.”

Each of the path a and the path b can include the first to the fifth sections with the same length as the autonomous driving path.

The first section can be a section in which the automated platooning vehicle or automated driving vehicle APV 400 can start from a starting point and travel to the ODD or less. When called by the main server 100, the PLV-p 200 can be platooning the APV 400 up to the ODD (i.e., second to fourth sections in FIG. 6) during the first section. The first section can be referred to as a first section or a first mile.

For example, the PLV-p 200 can platoon the APV 400 carrying an object from a warehouse to the ODD. For example, the PLV-p 200 can be a PLV-p 200 of the warehouse side that can travel in platooning in the first section.

Here, the first section of the path a can be located closer to the first section of the autonomous driving path than the first section of path b.

The second section can be a section in which the APV 400 can autonomously drive after entering the ODD. The APV 400 (automated driving vehicle) can independently perform Level 4 autonomous driving after entering the ODD.

When the APV 400 enters the second section, the APV 400 can transmit position information about a current position of the APV 400 or driving information about the vehicle to the main server 100. When the position information or the driving information is transmitted from the APV 400, the main server 100 can search for the first subscriber leader vehicle PLV-s1 300a that is driving in the second section of the path a or the second subscriber leader vehicle PLV-s2 300b that is driving in the second section of the path b.

The second section of path a can be located closer to the second section of the autonomous driving path than the second section of path b.

The third section can be a section in which the APV 400, which is autonomously driving in the ODD, cannot autonomously drive due to unusual matters (e.g., road construction, traffic accidents, traffic congestion). For example, when a situation in which Level 4 autonomous driving is impossible due to temporary road construction occurs while the APV 400 performs autonomous driving in the ODD, the automated platooning vehicle (or automated driving vehicle or unmanned driving vehicle) (APV) 400 can transmit an event signal including information about the situation to the main server 100.

When an event signal is transmitted from the APV 400, the main server 100 can transmit current position information and driving information of each of the first subscriber leader vehicle PLV-s1 300a and the second subscriber leader vehicle PLV-s2 300b.

The APV 400 can select one of the first subscriber leader vehicle PLV-s1 300a and the second subscriber leader vehicle PLV-s2 300b, closest to the APV 400 based on the current position information and driving information provided from the main server 100.

For example, in FIG. 6, since the third section of the path b is closer to the third section of the autonomous driving path than the third section of the path a, the APV 400 can select the second subscriber leader vehicles PLV-s2 300b that are driving on the path b.

The APV 400 can share the driving information, the position information, and the like while performing V2V communication with the selected second subscriber leader vehicle PLV-s2 300b.

Thereafter, the APV 400 can be associated with the second subscriber leader vehicle PLV-s2 300b. That is, the APV 400 can switch from Level 4 autonomous driving to platooning by the second subscriber leader vehicle PLV-s2 300b.

The second subscriber leader vehicle PLV-s2 300b can temporarily platoon the APV 400 during a third section in which the APV 400 cannot autonomously drive.

However, embodiments of the present disclosure are not necessarily limited thereto, and the APV 400 can perform platooning to a section or a path targeted by the APV 400 using the plurality of PLV-s 300, if necessary or more preferred or safer.

The fourth section can be a section in which the automated platooning vehicle 400 (APV) can resume autonomous driving during platooning. The APV 400 can perform Level 4 autonomous driving alone again during platooning with the second subscriber leader vehicle (PLV-s2 300b).

The fifth section can be a section in which the APV 400 can get out of the ODD, enter the city center, and travel to a destination. When called by the main server 100, the PLV-p 200 can platoon the APV 400 to the destination during the fifth section. The fifth section can be referred to as a last section or a last mile.

For example, the PLV-p 200 can platoon the APV 400 deviating from the ODD to a destination in the center of the city. For example, the PLV-p 200 can be the PLV-p 200 of city side capable of platooning in the fifth section (e.g., different than the PLV-p 200 of the first section).

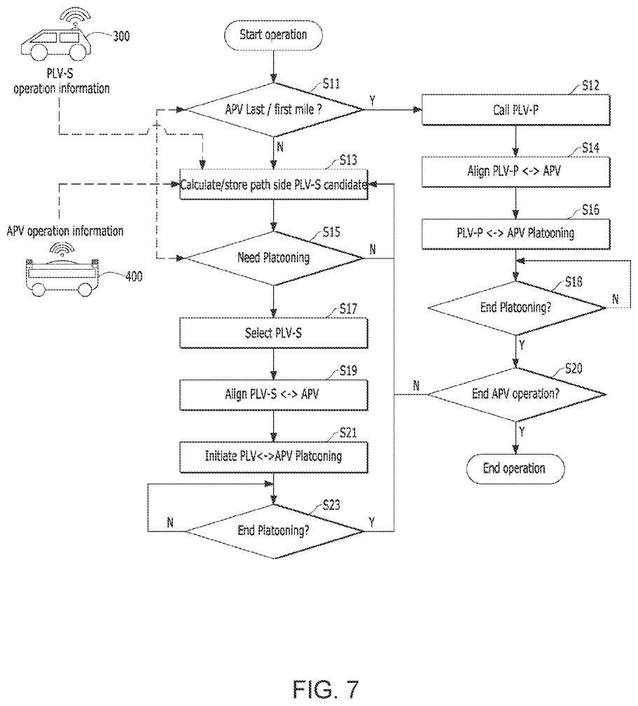

FIG. 7 is a diagram illustrating an operation of a main server according to an embodiment of the present disclosure.

Referring to FIG. 7, the main server 100 according to an embodiment of the present disclosure can operate as follows.

When the APV 400 starts to drive, the main server 100 can receive current position information or driving information from the APV 400.

When the APV 400 is driving in the first section or the last section (Yes in operation S11), the main server 100 can call the PLV-p 200 in operation S12.

Thereafter, the main server 100 can provide information so that the APV 400 and the PLV-p 200 are associated to each other. The APV 400 and the PLV-p 200 can share and be associated with the driving information provided from the main server 100 using V2V communication (operation S14).

Thereafter, the pilot leader vehicle (PLV-p) 200 can perform platooning with the associated APV 400 to the ODD (operation S16).

When the APV 400 enters the ODD, the pilot leader vehicle (PLV-p) 200 can terminate platooning (operation S18).

The APV 400 that has entered the ODD can terminate driving when autonomous driving or platooning is all terminated (operation S20).

When the APV 400 is driving a path other than the first section or the last section (No in operation S11), the main server 100 can search for a plurality of PLV-s 300 for each section of the path, receive driving information from the plurality of PLV-s 300, and calculate the driving information in operation S13.

When an event occurs during autonomous driving and autonomous driving is impossible, the APV 400 can determine that platooning is necessary (operation S15).

Accordingly, the APV 400 can receive the driving information on the plurality of PLV-s 300 from the main server 100 and select one of the plurality of PLV-s 300 closest to the APV 400 (operation S17).

Thereafter, the main server 100 can provide information so that the APV 400 and the selected PLV-s 300 are associated with each other. The APV 400 and the PLV-s 300 can share the driving information provided from the main server 100 and be associated with each other using V2V communication (operation S19).

Thereafter, the APV 400 can perform platooning with the selected PLV-s 300 (operation S21).

When it is determined that autonomous driving is possible in the ODD, the APV 400 can terminate platooning with the PLV-s 300 (operation S23).

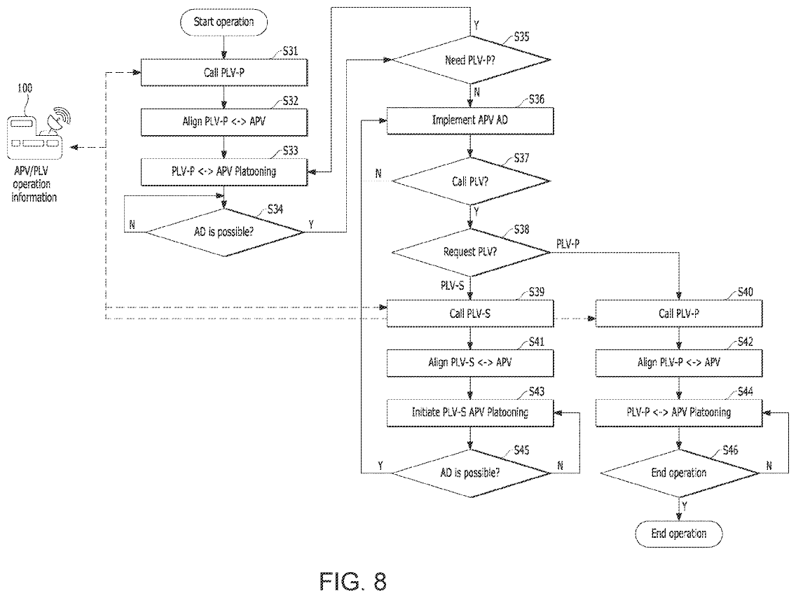

FIG. 8 is a diagram for describing an operation of an automated platooning vehicle according to an embodiment of the present disclosure.

Referring to FIG. 8, a diagram for describing an operation of an APV 400 according to an embodiment of the present disclosure will be hereinafter described.

When starting to drive, the APV 400 can provide current position information or driving information, or the like to the main server 100 and call the PLV-p 200 (operation S31).

The APV 400 can be associated with the called PLV-p 200 (operation S32).

The APV 400 can perform platooning with the associated pilot leader vehicle (PLV-p) 200 (operation S33). The automated platooning vehicle 400 (APV) can maintain platooning according to whether autonomous driving is possible (operation S34).

That is, the APV 400 can perform platooning with the PLV-p 200 until it enters the ODD (operation S35), and can drive autonomously after entering the ODD (operation S36).

That is, the APV 400 can perform platooning in a group with the PLV-p 200 until it enters the ODD (operation S35), and can drive autonomously after entering the ODD (operation S36).

For example, when it is determined that autonomous driving cannot be performed in the ODD, the APV 400 can request the main server 100 for the PLV-s 300 (operation S38) and call the PLV-s 300 (operation S39).

Thereafter, the APV 400 can be associated with the called PLV-s 300 (operation S41) and can perform platooning with the called PLV-s 300 (operation S43).

When it is determined that autonomous driving is possible during platooning (Yes in operation S45), the APV 400 can terminate platooning with the PLV-s 300 and can autonomously drive (operation S36).

Further, when the APV 400 gets out of the ODD, it can request the main server 100 for the PLV-p 200 (operation S38) and call the PLV-p 200 (operation S40). For example, when the APV 400 enters the downtown or off of the ODD, it can request the main server 100 to connect to the PLV-p 200 (operation S38) and then call the PLV-p 200 (operation S40).

Thereafter, the APV 400 can be linked to the called PLV-p 200 (operation S42) and can perform platooning with the called PLV-p 200 (operation S44).

The APV 400 can enter the city center and perform platooning until it arrives at the destination, and can terminate driving when it arrives (operation S46).

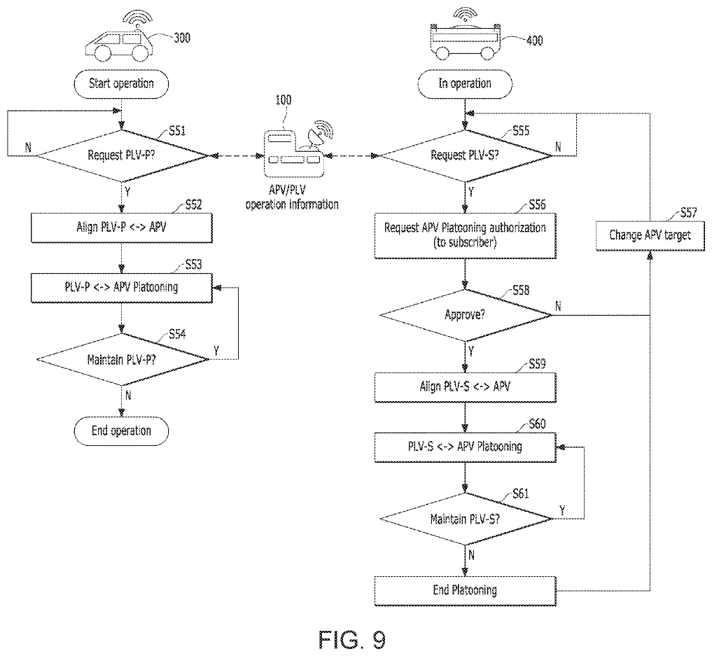

FIG. 9 is a diagram illustrating an operation of the pilot leader vehicle (PLV) according to an embodiment of the present disclosure.

Referring to FIG. 9, a diagram illustrating an operation of the leader vehicle (PLV) according to an embodiment of the present disclosure will be hereinafter described.

First, the PLV-p 200 starts operation.

When the driving information or the request signal for the APV 400 is transmitted from the main server 100 (operation S51), the PLV-p 200 can be associated with the APV 400 (operation S52).

The PLV-p 200 can perform platooning with the associated APV 400 (operation S53).

The PLV-p 200 can maintain platooning until the APV 400 enters the ODD (operation S54).

When the APV 400 enters the ODD, the PLV-p 200 can terminate platooning with the APV 400 and can terminate driving.

The PLV-s 300 can travel along a predetermined path.

When a request signal for the APV 400 is transmitted from the main server 100 during driving (operation S55), the PLV-s 300 can transmit an approval request signal to the APV 400 using V2V communication (operation S56).

When an approval signal is transmitted from the APV 400 (Yes in operation S58), the PLV-s 300 can be associated with the APV 400 (operation S59). When the approval signal is not transmitted from the APV 400 (operation S58, No), the PLV-s 300 can change the target of the APV 400 (operation S57).

The PLV-s 300 can perform platooning with the associated APV 400 when receiving the approval (operation S60).

The PLV-s 300 can maintain platooning with the APV 400 until the APV 400 performs autonomous driving again or gets out of the ODD and enters the city center (operation S61).

Thereafter, when it is not necessary to maintain platooning, the PLV-s 300 can terminate platooning with the PLV-s 300.

The above-described embodiments can be implemented in the form of a non-transitory recording medium for storing instructions executable by a computer. The instructions can be stored in the form of a program code, and when executed by a processor, can generate a program module to perform operations of the disclosed embodiments. The recording medium can be implemented as a computer-readable recording medium.

The non-transitory computer-readable recording medium includes all types of recording media in which computer-readable instructions are stored. For example, there can be a Read Only Memory (ROM), a Random Access Memory (RAM), a magnetic tape, a magnetic disk, a flash memory, an optical data storage device, etc.

Also, in the embodiments described above, the server 100 and the automated vehicle can include a processor (e.g., computer, microprocessor, CPU, ASIC, circuitry, logic circuits, etc.) and a non-transitory computer-readable recording medium. The computer-readable recording medium of each can store a computer program for performing the corresponding functionality as described above and the processor can read in the program to execute to perform the functionality.

The embodiments disclosed above have been described with reference to the accompanying drawings. It will be understood by one of ordinary skill in the art to which the present disclosure pertains that embodiments of the present disclosure can be implemented in a form different from the disclosed embodiments without changing the technical spirit or essential feature of the present disclosure. The disclosed embodiments are illustrative and should not be construed as necessarily limiting.

What is claimed is:

1. A method of controlling an automated platooning vehicle for driving on a traveling path including n-th to (n+2)-th (n is integer) sections, the method comprising:
receiving, from a server, information of a first leader vehicle capable of leading the automated platooning vehicle during the n-th section;
performing platoon driving in association with the first leader vehicle at the n-th section;
performing autonomous driving of the automated platooning vehicle out of association with the first leader vehicle during the (n+1)-th section;
receiving, from the server, information of a second leader vehicle capable of leading the automated platooning vehicle during the (n+2)-th section; and
performing platoon driving in association with the second leader vehicle during the (n+2)-th section.

2. The method of claim 1, wherein the performing of the autonomous driving during the (n+1)-th section comprises transmitting a request for information of at least one subscriber leader vehicle traveling around the traveling path to the server in response to an event situation occurring.

3. The method of claim 2, wherein the performing of the autonomous driving during the (n+1)-th section further comprises performing platoon driving in association with a subscriber leader vehicle whose information is received from the server.

4. The method of claim 3, wherein the performing of the autonomous driving during the (n+1)-th section further comprises autonomously driving again the automated platooning vehicle out of association with the subscriber leader vehicle in response to the event situation being terminated.

5. The method of claim 3, wherein the performing of the autonomous driving during the (n+1)-th section further comprises selecting one among the at least one subscriber leader vehicle based on information of the at least one subscriber leader vehicle received from the server.

6. The method of claim 1, wherein the automated platooning vehicle is an unmanned vehicle.

7. A method of operating a platooning service for an automated platooning vehicle traveling on a traveling path including n-th to (n+2)-th (n is integer) sections, the method comprising:
calling, by a server, a first leader vehicle capable of leading the automated platooning vehicle during the n-th section;
performing, by the automated platooning vehicle, platoon driving in association with the first leader vehicle;
performing, by the automated platooning vehicle, autonomous driving out of association with the first leader vehicle during the (n+1)-th section;
calling, by the server, a second leader vehicle capable of leading the automated platooning vehicle during the (n+2)-th section; and
performing, by the automated platooning vehicle, platoon driving in association with the second leader vehicle during the (n+2)-th section.

8. The method of claim 7, wherein performing the autonomous driving comprises transmitting, by the automated platooning vehicle, a request for information of at least one subscriber leader vehicle traveling around the traveling path to the server when a predetermined event situation occurs.

9. The method of claim 8, wherein performing the autonomous driving further comprises performing, by the automated platooning vehicle, platoon driving in association with a subscriber leader vehicle whose information is received from the server.

10. The method of claim 9, wherein performing the autonomous driving further comprises autonomously driving again by the automated platooning vehicle out of association with the subscriber leader vehicle when the event situation is terminated.

11. The method of claim 9, wherein performing the autonomous driving further comprises selecting, by the automated platooning vehicle, one among the at least one subscriber leader vehicle based on information of the at least one subscriber leader vehicle received from the server.

12. The method of claim 7, wherein the automated platooning vehicle is an unmanned vehicle.

13. An automated platooning vehicle configured to communicatively connect to a server at a time while traveling a path including an n-th section to an (n+2)-th (n is integer) section, the automated platooning vehicle comprising a computer-readable recording medium storing a computer program configured for performing platoon driving and autonomous driving, and a processor configured to execute the computer program, wherein the processor, when executing the computer program, is configured to perform:
receiving from a server information of a first leader vehicle capable of leading the automated platooning vehicle during the n-th section;
performing platoon driving in association with the first leader vehicle at the n-th section;
performing autonomous driving of the automated platooning vehicle out of association with the first leader vehicle during the (n+1)-th section;
receiving from the server information of a second leader vehicle capable of leading the automated platooning vehicle during the (n+2)-th section; and
performing platoon driving in association with the second leader vehicle during the (n+2)-th section.

14. The automated platooning vehicle of claim 13, wherein performing the autonomous driving during the (n+1)-th section comprises transmitting a request for information of at least one subscriber leader vehicle traveling around the traveling path to the server in response to an event situation occurring.

15. The automated platooning vehicle of claim 14, wherein performing the autonomous driving during the (n+1)-th section further comprises performing platoon driving in association with a subscriber leader vehicle whose information is received from the server.

16. The automated platooning vehicle of claim 15, wherein performing the autonomous driving at the (n+1)-th section further comprises autonomously driving again the automated platooning vehicle out of association with the subscriber leader vehicle in response to the event situation being terminated.

17. The automated platooning vehicle of claim 15, wherein performing the autonomous driving during the (n+1)-th section further comprises selecting one among the at least one subscriber leader vehicle based on information of the at least one subscriber leader vehicle received from the server.

18. The automated platooning vehicle of claim 13, wherein the automated platooning vehicle is an unmanned vehicle.
